(19) United States
(12) Patent Application Publication
(10) Pub. No.: US 2023/0340161 A1
(43) Pub. Date: Oct. 26, 2023

(54) CELLULOSE-CONTAINING MATERIALS

(71) Applicants: Mirshahin Seyed Saleh, Christchurch (NZ); Amy Clare Cruickshank, Lincoln (NZ); Robert James McClelland Kelly, Christchurch (NZ)

(72) Inventors: Mirshahin Seyed Saleh, Christchurch (NZ); Amy Clare Cruickshank, Lincoln (NZ); Robert James McClelland Kelly, Christchurch (NZ)

(21) Appl. No.: 18/025,591

(22) PCT Filed: Sep. 15, 2021
(86) PCT No.: PCT/NZ2021/050163

§ 371 Date: Mar. 9, 2023

(30) Foreign Application Priority Data
Sep. 15, 2020 (NZ) 2020903291

(51) Int. Cl. C08B 3/04; C08B 1/00; C08B 3/28

(52) U.S. Cl. CPC C08B 3/04; C08B 1/003; C08B 3/28; D01F 11/02

(57) ABSTRACT

Disclosed is a process for solubilising cellulose and coagulating the resulting solution to form a cellulose-containing material. The process comprises contacting a cellulose source with a solvent comprising zinc ions and formic acid to provide a solution, coagulating the solution to provide a solid material, and isolating the solid material after treatment, to provide the cellulose-containing material. The process further involves a method of stabilising the solid material, such as treating the solid material with a reducing agent, treating the solid material in water at an elevated temperature, treating the solid material with an organic solvent, pre-treating the cellulose-containing solution with a freeze-thaw cycle and/or isolating a cellulose formate intermediate. The process can further comprise solubilising protein and coagulating the resulting solution to form a cellulose/protein-containing material.

### FIELD OF THE INVENTION

The present invention relates to a process for solubilising cellulose and coagulating the resulting solution to form a cellulose-containing material. The process can further comprise solubilising protein and coagulating the resulting solution to form a cellulose/protein-containing material.

### BACKGROUND

Natural fibres such as cotton, wool and silk have many desirable properties in textile and other applications, including sustainability due to their natural origin, their interaction with moisture and the resulting comfort next to the skin. Their use in textile applications is widespread. Natural fibres have limitations, including their fibre diameter, which is a key determinant of softness and results from the natural fibre formation process, as does their staple length. In addition, the surface structure of some fibres, such as wool, is not smooth and this may create problems during fibre processing and use.

Fibres can be made through extrusion processes, such as wet spinning or melt spinning. Such fibres are typically continuous filament, with a controllable diameter and with a smooth or controllable surface topography. Extrusion processes may, therefore, overcome several of the limitations of natural fibres.

Many materials, such as cellulose and keratin in their native states, for example in cotton or in wool, are not, however, suitable for wet spinning or melt spinning. Low degree of polymerisation (DP) native cellulose with a DP of up to 1000, such as wood pulp, can be processed through chemical modification to make it soluble in a wet spinning system, such as in the well-known rayon and lyocell processes. These processes are not generally suitable for cellulose with a DP over 1200, such as cotton, because they do not render the cellulose soluble.

Derivatisation to create cellulose acetate also provides materials that are extrudable through wet spinning or solvent spinning systems, and such materials are commonly used in the creation of textile fibres. Unlike cellulose acetate, however, the previous use of cellulose formate has been limited due to the instability of the material and its susceptibility to degradation.

The use of zinc salts in the presence of formic acid to dissolve cellulose is known in the art (CN 105153316 and US 2014/0090640), however, these approaches leave the cellulose susceptible to hydrolysis and dissolution under acidic conditions. This leads to loss of degree of polymerisation and weakening of any subsequently reconstituted materials.

Cellulose formate derivatives have been prepared using formic acid and zinc halides under concentrated conditions that may avoid hydrolysis (GB 260650 and GB 275641). Other processes for preparing cellulose formate have relied on additional phosphoric acid to achieve the reaction conditions favourable for formylation (U.S. Pat. No. 4,839,113).

Keratin derived from wool or other sources, such feathers, horns and hooves, has also been processed to create extruded fibres, typically with chemical modification to create a derivative suitable for wet spinning. Such derivatisation may use reduction (GB 690566), sulfitolysis (U.S. Pat. No. 7,465,321) or alkali treatment (WO 2013/043062) to create an extrudable liquid.

WO 2020/060419 discloses a process for solubilising cellulose and coagulating the resulting solution to form a cellulose-containing material. The process comprises contacting a cellulose source with a solvent comprising zinc ions and formic acid to provide a solution, coagulating the solution to provide a solid material, treating the solid material with an oxidising agent or by immersing the solid material in water and freezing the water in which the solid material is immersed, and isolating the solid material after treatment, to provide the cellulose-containing material. The process can further comprise solubilising protein and coagulating the resulting solution to form a cellulose/protein-containing material.

Accordingly, it is an object of the present invention to go some way to avoiding the above disadvantages; and/or to at least provide the public with a useful choice.

Other objects of the invention may become apparent from the following description which is given by way of example only.

### SUMMARY OF THE INVENTION

In a first aspect, the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with a reducing agent; and
(d) isolating the solid material from (c) to provide the cellulose-containing material.

Preferably, the reducing agent is selected from sodium sulfite, sodium sulfide, sodium metabisulfite, sodium borohydride, sodium hydrogen sulfide and mixtures of any two or more thereof. More preferably, the reducing agent is sodium hydrogen sulfide.

In one embodiment, the process further comprises isolating the solid material from (b) prior to (c). The process may further comprise drying the isolated solid material prior to (c).

In one embodiment, the solid material is immersed in a reducing agent solution for between about 1 minute and about 24 hours.

In another embodiment, the process further comprises isolating the solid material from (b) concurrently with (c).

In a second aspect, the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with an organic solvent; and
(d) isolating the solid material from (c) to provide the cellulose-containing material.

Preferably, the organic solvent is a volatile organic solvent. In one embodiment, the organic solvent is selected from methyl formate, ethyl formate, ethyl acetate, acetone, ethyl alcohol and mixtures of any two or more thereof. More preferably, the organic solvent is a volatile ester solvent. In one embodiment, the organic solvent is selected from methyl formate and ethyl formate.

In one embodiment, the organic solvent is substantially anhydrous. In another embodiment, the organic solvent comprises water. Preferably, the organic solvent is selected from 98-100% w/v methyl formate, 98-100% w/v ethyl formate, 20% w/v aqueous methyl formate and 9% w/v aqueous ethyl formate.

In one embodiment, the treatment in (c) comprises rinsing the solid material from (b) with the organic solvent or immersing the solid material from (b) in the organic solvent. In one embodiment, the process further comprises isolating the solid material from (b) prior to (c).

In another embodiment, the process further comprises isolating the solid material from (b) concurrently with (c).

In a third aspect, the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) in water at a temperature of at least about 95° C.; and
(d) isolating the solid material from (c) to provide the cellulose-containing material.

In one embodiment, the solid material is immersed in water at a temperature of at least about 95° C. for about 2 minutes.

In one embodiment, the process further comprises isolating the solid material from (b) prior to (c).

In another embodiment, the process further comprises isolating the solid material from (b) concurrently with (c).

In a fourth aspect, the invention provides a process for producing a cellulose-containing material comprising:
(a) contacting a cellulose source with a solvent comprising zinc ions and formic acid to provide a solution;
(b) freezing and then thawing the solution from (a) to provide a thawed solution;
(c) extruding the thawed solution from (c) into a coagulation bath to provide a solid material; and
(d) isolating the solid material from (c) to provide the cellulose-containing material.

In a fifth aspect, the invention provides a process for producing cellulose formate comprising:
(a) contacting a cellulose source with a solvent comprising zinc ions and formic acid to provide a solution;
(b) adding water to the solution from (a) to provide a precipitate;
(c) isolating the precipitate from (b);
(d) immersing the precipitate from (c) in water;
(e) freezing the water in which the precipitate is immersed; and drying the precipitate from (d) to provide cellulose formate.

In one embodiment, the process further comprises grinding the cellulose formate material into a powder.

In one embodiment, (e) involves freezing the water for at least 2 hours. In one embodiment, (e) involves freezing the water for about 24 hours.

In a sixth aspect, the present invention provides a process for producing a cellulose-containing material comprising:
(a) dissolving the cellulose formate material of the invention in a solvent to provide a solution;
(b) extruding the solution of (a) into a coagulation bath to provide a solid material;
(c) isolating the solid material from (b) to provide the cellulose-containing material.

In one embodiment, the solvent in (a) is selected from formic acid or dimethyl sulfoxide.

In one embodiment of the process of the first, second, third, fourth or sixth aspect of the invention, the coagulation bath comprises a halide salt. Preferably, the halide salt is selected from zinc chloride, zinc bromide, zinc iodide, sodium chloride, sodium bromide, sodium iodide, potassium chloride, potassium bromide, potassium iodide, chloride salts of other metals, bromide salts of other metals, iodide salts of other metals and mixtures of any two or more thereof. More preferably, the halide salt is selected from potassium iodide, sodium bromide, zinc chloride and mixtures of any two or more thereof. Most preferably, the halide salt is zinc chloride.

In one embodiment, the concentration of the halide salt in the coagulation bath is between about 1% w/v and about 60% w/v. In one embodiment, the concentration of the halide salt in the coagulation bath is between about 10% w/v and about 50% w/v.

In one embodiment, the solution from (a) further comprises a protein source and the process produces a cellulose/protein-containing material. Preferably, the protein source is keratin protein powder.

In one embodiment of the process of the first, second, third, fourth or sixth aspect of the invention, the solid material comprises a fibre or a film.

In one embodiment, the cellulose source comprises cotton, wood pulp or a plant part. In one embodiment, the cellulose source comprises a mixture of two or more cellulose sources.

Preferably, the solvent in (a) comprises less than about 10% w/w water, less than about 2% w/w water, or is substantially anhydrous. More preferably, the solvent in (a) is substantially anhydrous.

Preferably, the solvent in (a) comprises a solution of zinc formate and formic acid. More preferably, the concentration of zinc formate is about 20% w/v to about 40% w/v.

In a further aspect, the invention provides a material produced by a process of the first, second, third, fourth, fifth or sixth aspect of the invention.

Although the present invention is broadly as defined above, those persons skilled in the art will appreciate that the invention is not limited thereto and that the invention also includes embodiments of which the following description gives examples.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### DETAILED DESCRIPTION

The term “comprising” as used in this specification means “consisting at least in part of”. When interpreting statements in this specification which include that term, the features, prefaced by that term in each statement or claim, all need to be present but other features can also be present. Related terms such as “comprise” and “comprises” are to be interpreted in the same manner.

The term “% w/v” as used in this in this specification means the weight in grams of a solute per 100 ml of a solution.

The present invention broadly relates to a process for producing cellulose-containing materials by solubilising cellulose from a cellulose source then processing the resulting solution to produce, for example, reconstituted cellulose fibres and films. The process can also further comprise solubilising protein and processing the resulting solution to produce, for example, reconstituted cellulose/protein fibres and films. Surprisingly, the inventor has discovered methods for performing the process described in WO 2020/060419 without the oxidising step and/or freezing step. Accordingly, the present invention provides alternative methods of stabilising the products and intermediates in processes for producing cellulose-containing materials and cellulose/protein containing materials. More specifically, alternative methods involving treatment of the solid material with a reducing agent, treatment of the solid material with an organic solvent, treatment of the solid material in water at an elevated temperature, pre-treatment of the cellulose-containing solution with a freeze-thaw cycle and/or isolation of a cellulose formate intermediate.

Without wishing to be bound by theory, it is thought that formylating natural polymer materials, such as cellulose, including cellulose having a high degree of polymerisation, and proteins, such as keratin, casein and fibroin, renders these generally insoluble natural polymer materials soluble in formic acid. The inventor previously determined that solvent systems comprising zinc ions and formic acid were able to formylate the natural polymer materials and so produce formic acid solutions suitable for further processing.

Extrusion of the resulting formic acid solutions into a coagulation bath generates products comprising the polymer materials. For example, wet spinning can be used to generate the materials as fibres.

Advantageously, a cellulose source and a protein source may be solubilised in the same solution, or in separate solutions that are then combined prior to extrusion.

Without wishing to be bound by theory, it is thought that the initial product of the extrusion comprises, for example, cellulose formate or cellulose/keratin formate, when the protein source comprises keratin. Cellulose formate is an unstable material, but the inventor has determined that process steps as described herein can stabilise the extruded material and generate cellulose and cellulose/protein fibres that are suitable for textile processing.

Accordingly, the present invention relates to a process for producing a cellulose-containing material comprising contacting a cellulose source with a solvent comprising zinc ions and formic acid to provide a solution, extruding the solution into a coagulation bath to provide a solid material, treating the solid material, and isolating the solid material after treatment, to provide the cellulose-containing material.

### Solvent Comprising Zinc Ions and Formic Acid

The solvent comprises zinc ions and formic acid. In one embodiment, the solvent comprises a solution of zinc formate in formic acid.

The concentration of zinc formate may be about 20% w/v to about 40% w/v. It may be difficult to dissolve a cellulose source in solutions having significantly lower or higher concentrations of zinc formate. In one embodiment, the concentration of zinc formate is about 40% w/v.

The solvent may be prepared by dissolving zinc formate in formic acid. Preferably, the zinc formate comprises less than about 5% w/w water, more preferably less than about 2% w/w water. More preferably, the zinc formate is substantially anhydrous.

While zinc formate is commercially available as a dihydrate, the dihydrate has poor solubility in formic acid.

Preferably, the formic acid is at least 90% w/w formic acid. More preferably, the formic acid is about 95% w/w formic acid, more preferably about 98% w/w formic acid. Formic acid is commercially available in such concentrations.

In a preferred embodiment, the solvent comprises a concentration of anhydrous zinc formate of about 20% w/v to about 40% w/v in 98% formic acid.

Advantageously, minimising the amount of water in the solvent has been found to improve the solubility of the cellulose source material in the solvent.

The solvent typically comprises less than about 10% w/w water. Preferably, the solvent comprises less than about 5% w/w water. More preferably, the solvent comprises less than about 2% w/w water. In one embodiment, the solvent comprises less than about 1% w/w water.

The solubility of cellulose in the solvent typically increases as the water content of the solvent decreases.

Zinc formate may be prepared by reacting a zinc halide, including zinc chloride, zinc bromide or a mixture thereof, with concentrated formic acid. The resulting zinc formate can be isolated, typically as a powder, and dried to provide anhydrous zinc formate. The zinc formate may then be dissolved in formic acid to provide the solvent comprising zinc ions and formic acid.

Alternatively, the solvent comprising zinc ions and formic acid may be produced in situ by reacting the zinc halide with concentrated formic acid and without isolating zinc formate.

The concentration of zinc halide in the formic acid is typically about 10% w/v to about 50% w/v. Preferably, the concentration of zinc halide is about 20% w/v to about 50% w/v. More preferably, the concentration of zinc halide is about 20% w/v to about 45% w/v. In one embodiment, the concentration of zinc halide is about 40% w/v. In another embodiment, the concentration of zinc halide is about 25% w/v.

Preferably, the zinc halide comprises less than about 5% w/w water, more preferably less than about 2% w/w water. More preferably, the zinc halide is substantially anhydrous.

In a preferred embodiment, the solvent comprises a concentration of anhydrous zinc chloride of about 20% w/v to about 50% w/v in 98% formic acid.

### Preparation of Cellulose-Containing Solution

The solvent is contacted with a cellulose source to provide a solution. During the contacting, the cellulose source dissolves. A variety of cellulose sources are suitable for use in the invention. For example, native cellulose sources having a relatively low degree of polymerisation, but also cellulose sources having a relatively high degree of polymerisation (DP).

Low DP cellulose sources, having a DP of up to about 1000 or about 800-1200, such as wood pulp, are readily dissolved in the solvent of the invention. Wood pulp can also be dissolved in other common solvent systems, such as those using xanthate, cuprammonium complex or N-methylmorpholine N-oxide. But dissolution of higher DP cellulose sources is generally not possible in these solvent systems.

Cotton linter typically has a DP of about 1000-2000 and cotton may have a DP of about 1500-5000 or higher.

Surprisingly, the zinc ion/formic acid solvent of the invention has been found to dissolve relatively high DP cellulose sources, for example cellulose sources having a DP of up to about 5000, such as cotton (including Egyptian cotton).

In one embodiment, the cellulose source comprises cellulose with a DP of at least about 1000. In another embodiment, the cellulose source comprises cellulose with a DP of at least about 1200.

The cellulose source may comprise a mixture of two or more cellulose sources, each of which has the same or a different DP. For example, the cellulose source may comprise a mixture of two or more of cotton, wood pulp and plant parts. In one embodiment, the cellulose source comprises a mixture of cotton and wood pulp. In another embodiment, the cellulose source comprises a mixture of cotton and plant parts. In another embodiment, the cellulose source comprises a mixture of wood pulp and plant parts. In another embodiment, the cellulose source comprises a mixture of cotton, wood pulp and plant parts.

Advantageously, the solvent of the present invention may be used to solubilise cellulose from whole and/or unprocessed plant parts, such as leaves, petals and fruit skins. Preferred plant parts include leaves and petals.

Such plant parts typically contain additional components, such as hemi-cellulose, pectin and other non-structural polysaccharides, which interfere with the xanthate or cuprammonium processes used in rayon processing and render them ineffective.

Advantageously, such plant parts may be dissolved using the solvent of the present invention.

Other features of plant parts, for example colour and/or fragrance, associated with cellulose sources, such as leaves and flower petals, also cannot be processed through existing cellulose dissolution routes. Advantageously, cellulose-containing materials produced by the process of the present invention can retain the colour and/or fragrance features of the cellulose source. For example, fibres that are rose coloured and have a rose fragrance can be produced using rose petals as the cellulose source. Similarly, fibres that are green or brown can be produced using the same coloured leaves as the cellulose source.

Accordingly, the cellulose-containing material may comprise one or more pigments from the cellulose source. Alternatively or additionally, the cellulose-containing material may comprise one or more fragrances from the cellulose source.

Without wishing to be bound by theory, it is thought the solvent of the invention generates cellulose formate with a low degree of substitution, generally 2 or less, and may generate cellulose formate with a degree of substitution of 1 or less. While cellulose formate with a high degree of substitution has a high solubility in a range of solvent systems, including concentrated formic acid, DMF and DMSO, previous approaches to using cellulose formate with a low degree of substitution, for example 2 or less or 1 or less, have typically not provided solutions with a high enough concentration (sufficient solubility of cellulose) to allow wet spinning.

Advantageously, the solvent system of the invention provides cellulose formate with a low degree of substitution, and is able to produce solutions with a sufficiently high concentration of cellulose for subsequent wet spinning of fibres. In one embodiment, the solvent of the invention dissolves up to about 15% w/v cellulose. For example, the solvent of the invention dissolves about 15% w/v cellulose, about 14% w/v cellulose, about 13% w/v cellulose, about 12% w/v cellulose, about 11% w/v cellulose, about 10% w/v cellulose, about 9% w/v cellulose, about 8% w/v cellulose, about 7% w/v cellulose, about 6% w/v cellulose, about 5% w/v cellulose, about 4% w/v cellulose, about 3.5% w/v cellulose, about 3% w/v cellulose, about 2.5% w/v cellulose or about 2% w/v cellulose. In one embodiment, the solvent of the invention dissolves up to about 10% w/v cellulose in a solvent comprising 98% formic acid. In another embodiment, the solvent of the invention dissolves up to about 5% w/v cellulose in a solvent comprising 98% formic acid. In another embodiment, the solvent of the invention dissolves up to about 4% w/v cellulose in a solvent comprising 98% formic acid.

The cellulose source and the solvent are typically contacted for a time sufficient to dissolve the cellulose. The cellulose source may conveniently be contacted by immersing it into the solvent. However, the invention is not limited thereto and other suitable methods will be apparent to those persons skilled in the art.

The contacting time may depend on the DP of the cellulose in the cellulose source. In one embodiment, the contacting time is about 4 hours to about 9 hours. Contacting times outside this range may, however, still be useful. For example, a contacting time of about 4 hours may be sufficient to dissolve cellulose having a relatively low DP, while a contacting time of about 9 hours may be required to dissolve cellulose having a relatively high DP.

In one embodiment, the mixture of cellulose source and solvent is agitated, stirred or otherwise mixed during contacting. The agitation, stirring or mixing may be continuous or discontinuous during the contacting.

The amount of cellulose source may be up to about 15% w/v of solvent. For example, the amount of cellulose source may be up to about 15% w/v, up to about 14% w/v, up to about 13% w/v, up to about 12% w/v, up to about 11% w/v, up to about 10% w/v, up to about 9% w/v, up to about 8% w/v, up to about 7% w/v, up to about 6% w/v, up to about 5% w/v, up to about 4% w/v, up to about 3% w/v, up to about 2% w/v, or up to about 1% w/v of solvent. In one embodiment, the amount of cellulose source is up to about 10% w/v of solvent. In another embodiment, the amount of cellulose source is up to about 4% w/v of solvent. In another embodiment, the amount of cellulose source is up to about 3.5% w/v of solvent. In another embodiment, the amount of cellulose source is up to about 3% w/v of solvent. In another embodiment, the amount of cellulose source is up to about 2.5% w/v of solvent. In another embodiment, the amount of cellulose source is up to about 2.3% w/v of solvent. In another embodiment, the amount of cellulose source is up to about 2% w/v of solvent.

The temperature at which the contacting step is performed may be, for example, about 15° C. to about 30° C. Temperatures outside this range may, however, still be useful. Advantageously, the contacting step may be performed at ambient (room) temperature, typically about 20° C. to about 25° C.

The resulting solution may comprise up to about 15% w/v cellulose. For example, the resulting solution may comprise up to about 15% w/v, up to about 14% w/v, up to about 13% w/v, up to about 12% w/v, up to about 11% w/v, up to about 10% w/v, up to about 9% w/v, up to about 8% w/v, up to about 7% w/v, up to about 6% w/v, up to about 5% w/v, up to about 4% w/v, up to about 3% w/v, up to about 2% w/v, or up to about 1% w/v of solvent. Accordingly, in one embodiment, the solution comprises about 10% w/v cellulose. In another embodiment, the solution comprises about 5% w/v cellulose. In another embodiment, the solution comprises about 4% w/v cellulose. In another embodiment, the solution comprises about 3.5% w/v cellulose. In another embodiment, the solution comprises about 3% w/v cellulose. In another embodiment, the solution comprises about 2.5% w/v cellulose. In another embodiment, the solution comprises about 2.3% w/v cellulose. In another embodiment, the solution comprises about 2% w/v cellulose.

The solution may be filtered to remove physical impurities and provide a homogeneous solution before extrusion.

Two or more solutions prepared from the same or different cellulose sources may be combined before extrusion.

Cellulose formate is a relatively unstable material. Decomposition of the substituents releases formic acid, which can hydrolyse and degrade the regenerated cellulose material. This instability has prevented the widespread use of cellulose formate, despite the extensive use of other cellulose derivatives, such as cellulose acetate. The stability of cellulose formate is inversely proportional to the degree of substitution. While a degree of substitution of 2 or 3 (cellulose diformate or cellulose triformate) leads to higher solubility in the solvent of the spinning solution, the resulting extruded fibres are generally unstable, decomposing to release formic acid in the presence of heat leading to fibre degradation. Advantageously, the processes of the present invention have been found to produce stable cellulose formate materials with a degree of substitution of up to about 2. Such materials have further been found to be both sufficiently soluble for spinning and sufficiently stable for practical use as a textile fibre.

### Preparation of Protein-Containing Solution and Cellulose/Protein-Containing Solution

As explained above, keratin derived from wool or other sources such feathers, horns and hooves, can be processed to create extruded fibres, typically with chemical modification to create a derivative suitable for wet spinning. However, reconstituted protein fibres typically have relatively low tenacity and high brittleness when compared to protein fibres in their native state, such as silk and wool.

Advantageously, the process of the present invention can be used to produce a cellulose/protein-containing material. The combination of these two natural polymer materials in a single product may have the potential to go at least some way to overcoming the previously limiting problems of weakness and brittleness in reconstituted protein fibres and/or at least provide the public with a useful choice.

Protein sources may comprise keratin, such as wool, casein or fibroin, preferably silk. In one embodiment, the protein source comprises keratin. In another embodiment, the protein source comprises casein. In another embodiment, the protein source comprises fibroin.

Fibrous proteins (also known as scleroproteins) are generally inert and insoluble in water. Fibrous proteins form long protein filaments shaped like rods or wires. They are structural or storage proteins. Fibrous proteins include keratin and fibroin.

In one embodiment, the protein source comprises keratin. Suitable protein sources comprising keratin include, but are not limited to, wool, hair, horns, hooves and feathers. In one embodiment, particularly wherein the protein source comprises a material such as horns or hooves, the material may be comminuted prior to contact with the solvent.

In one embodiment, the protein source comprises wool, hair, or feathers, or a mixture of any two or more thereof. In another embodiment, the protein source comprises wool or feathers, or a mixture thereof. In a preferred embodiment, the protein source comprises wool, consists essentially of wool, or consists of wool.

Wool is a keratin protein fibre and is produced by various animals including sheep, goats, camels and rabbits. The fibre structure typically comprises a cuticle, cortex, and medulla, although fine wools may lack the medulla.

Preferably, the wool is sheep wool.

The diameter of sheep wool typically ranges from about 10 microns to about 45 microns. Fibre diameter is an important characteristic of wool in relation to its quality and price. Finer wools are softer and suitable for use in garment manufacturing. There are a limited number of consumer applications remaining for stronger wool types such as flooring, bedding, upholstery, and hand knitting yarns.

The protein source may comprise a mixture of two or more protein sources. For example, the protein source may comprise a mixture of two or more of keratin, preferably wool, casein or fibroin, preferably silk.

When the protein source comprises keratin, and preferably wool, a reducing agent may be added to the solvent. A preferred reducing agent is cysteine. Without wishing to be bound by theory, it is thought that cysteine assists with disulfide bond reduction and stabilisation of the zinc formate complex.

In one embodiment, the solvent comprises about 10% w/v to about 70% w/v cysteine. In another embodiment, the solvent comprises about 50% w/v cysteine.

The cysteine-containing solvent of the invention surprisingly dissolves whole wool up to a concentration of about 30% w/v.

Without wishing to be bound by theory, it is thought that keratin formate is formed during dissolution, in which the cystine component of the keratin protein is formylated.

Alternatively, the protein source may comprise keratin protein powder isolated from a keratin source such as wool, hair, horns, hooves, scales and feathers. The keratin protein powder may be prepared using a method as described in WO 2013/043062. However, the keratin protein powder may be prepared by any suitable keratin hydrolysis or extraction method known in the art, such as acid hydrolysis, alkali hydrolysis, enzyme hydrolysis, oxidative sulfitolysis or oxidation.

Advantageously, keratin protein powder may be dissolved in a solvent without a reducing agent, such as cysteine. Additionally, keratin protein powder is soluble in the solvent of the invention at high concentrations. In one embodiment, the keratin protein powder is soluble at a concentration of at least about 4% w/v of solvent. In another embodiment, the keratin protein powder is soluble at a concentration of at least 4.20% w/v of solvent.

Other protein sources, including those comprising casein and fibroin, are also soluble in the solvent of the invention. No reducing agent or cysteine is typically used for dissolution of these proteins, due to the absence or very low level of cystine in these protein sources.

The solvent of the invention may dissolve up to about 60% w/v of casein and up to about 20% w/v fibroin.

The protein source may be contacted with the solvent simultaneously or sequentially with the cellulose source. When the contacting is sequential, the protein source may be contacted with the solvent either before or after the cellulose source is contacted with the solvent.

For example, the solvent comprising dissolved protein can be contacted with a cellulose source, the solution provided by contacting a protein source with a solvent comprising zinc ions and formic acid being used to dissolve the cellulose. Alternatively, the solvent comprising dissolved cellulose can be contacted with a protein source, the solution provided by contacting a cellulose source with a solvent comprising zinc ions and formic acid being used to dissolve the protein. As a further alternative, a cellulose source and protein source can be simultaneously contacted with a zinc ion/formic acid solvent of the invention to provide a solution.

A preferred protein source comprises keratin protein powder. In those embodiments comprising contacting keratin protein powder and the solvent, the contacting is typically for a time sufficient to dissolve the protein source. In one embodiment, the contacting time is about 4 hours. Shorter or longer times may, however, still be useful.

As discussed above, when the protein source comprises a keratin such as wool, the solvent then preferably further comprises a reducing agent, preferably cysteine. In those embodiments, the contacting time is about 5 hours to about 8 hours. Contacting times outside this range may, however, still be useful.

The temperature at which this contacting step is performed may be, for example, up to about 35° C. Temperatures outside this range may, however, still be useful. Advantageously, the contacting step may be performed at ambient (room) temperature, typically about 20° C. to about 25° C.

The solution may be filtered to remove physical impurities and provide a homogeneous solution before extrusion.

Two or more solutions prepared from the same or different protein sources may be combined before extrusion.

Similarly, a solution prepared from a cellulose source may be combined with a solution prepared from a protein source prior to extrusion. Alternatively, one or more solutions prepared from one or more cellulose sources may be combined with one or more solutions prepared from one or more protein sources prior to extrusion.

As a further alternative, one or more cellulose/protein solutions may be combined, optionally with one or more solutions prepared from one or more cellulose sources and/or one or more solutions prepared from one or more protein sources.

### Isolation of Cellulose Formate and Protein Formate Intermediates

The solution comprising dissolved cellulose, or the solution comprising both dissolved cellulose and protein, can then be extruded and further processed to provide a cellulose-containing material or a cellulose/protein-containing material, respectively.

Alternatively, it may be advantageous to isolate a solid after the initial dissolution step, and use that solid to prepare a solution for extrusion and subsequent processing.

Accordingly, a cellulose formate solution may be prepared by contacting a cellulose source with a solvent of the invention, such as a solvent comprising zinc ions and formic acid. Cellulose formate may then be precipitated from the solution by adding water to the solution.

In one embodiment, the cellulose formate precipitate is immersed in water and then the water is frozen. Surprisingly, the inventor has found that freezing the cellulose formate precipitate in water may provide a more stable cellulose formate intermediate. Advantageously, the resulting isolated cellulose formate intermediate may be stored for a longer period of time.

Accordingly, another aspect of the present invention relates to a process for producing cellulose formate comprising:
(a) contacting a cellulose source with a solvent comprising zinc ions and formic acid to provide a solution;
(b) adding water to the solution from (a) to provide a precipitate;
(c) isolating the precipitate from (b);
(d) immersing the precipitate from (c) in water;
(e) freezing the water in which the precipitate is immersed; and drying the precipitate from (e) to provide cellulose formate.

In one embodiment, the cellulose formate is ground to provide cellulose formate powder.

The cellulose formate may be subsequently dissolved in a solvent, such as formic acid or dimethyl sulfoxide, and extruded into fibres in a process of the invention.

Accordingly, another aspect of the present invention relates to a process for producing a cellulose-containing material comprising:
(a) contacting a cellulose source with a solvent comprising zinc ions and formic acid to provide a solution;
(b) adding water to the solution from (a) to provide a precipitate;
(c) isolating the precipitate;
(d) immersing the precipitate from (c) in water;
(e) freezing the water in which the precipitate is immersed;
drying the precipitate from (d) to provide a cellulose formate intermediate;
(g) contacting the cellulose formate intermediate from (f) with a solvent to provide a solution;
(h) extruding the solution from (g) into a coagulation bath to provide a solid material; and
(g) isolating the solid material from (h) to provide the cellulose-containing material.

In one embodiment, the cellulose formate intermediate is contacted with formic acid to provide a solution, which is further processed to provide a cellulose-containing material. In another embodiment, the cellulose formate intermediate is contacted with dimethyl sulfoxide to provide a solution, which is further processed to provide a cellulose-containing material.

It may be advantageous to isolate the keratin formate. For example, keratin formate may be isolated from a solution in a solvent system comprising cysteine and wool by precipitation, for example by adding water to the solution. The resulting keratin formate precipitate may be isolated by filtration and dried.

Accordingly, in one embodiment, the process of the invention comprises:
(a) contacting a keratin source with a solvent comprising a reducing agent, zinc ions and formic acid to provide a solution;
(i) adding water to the solution from (a) to provide a precipitate;
(ii) isolating the precipitate from (i); and
(iii) drying the precipitate from (ii).

A preferred keratin source is wool.

The dried precipitate, which is thought to comprise keratin formate, may be dissolved in formic acid. The dried precipitate may also be added to the solution provided by contacting a cellulose source with a solvent comprising zinc ions and formic acid, prior to extrusion and subsequent further process steps.

Extrusion of the Solution into a Coagulation Bath

In the process of the present invention, the solution of cellulose or cellulose/protein in the solvent is extruded into a coagulation bath to provide a solid material.

Those persons skilled in the art will appreciate that the solution of cellulose or cellulose/protein can be extruded into a coagulation bath in any shape such that the solid material can be formed, for example, as a fibre, film, sheet, coating or particle.

In one embodiment, the solid material is formed as a film by extrusion of the solution through a narrow slit into a coagulation bath.

In another embodiment, the solution is formed into fibres using a conventional wet spinning machine typically used for viscose. In this embodiment, the solution is typically pumped through a spinneret into a coagulation bath.

Advantageously, the wet spinning process enables the production of fibres of any desired diameter by selecting the appropriate spinneret. The resulting fibres have a consistent diameter and may be produced as single long filaments. This contrasts with naturally occurring fibres, such as wool, which form as staples and for which the diameter is variable, and the length limited.

When the solid material is formed as fibres, the fibres may be wound onto a bobbin. For example, the extruded fibres may be collected on a take up roller, optionally drawn as required between rollers to improve fibre tensile properties, and then wound onto a bobbin. The fibres may also be cut if short staple fibres are required. In one embodiment, the solid material is formed as a plurality of short fibres by, for example, rapidly forcing the solution through a spinneret into the coagulation bath.

The coagulation bath typically comprises, consists essentially of or consists of water. However, the invention is not limited thereto. For example, the coagulation bath may comprise 1-10% v/v formic acid, a soluble formate salt and/or a halide salt.

The formate salt may be selected from, for example, lithium formate, sodium formate, potassium formate, calcium formate, copper formate, zinc formate, ammonium formate and mixtures of any two or more thereof. In one embodiment, the concentration of formate salt in the coagulation bath is between about 20% w/v and about 60% w/v.

Additionally or alternatively, the coagulation bath may comprise a halide salt. Advantageously, the use of a coagulation bath comprising a halide salt may assist in the spinning process and improve the efficiency of fibre formation. Without wishing to be bound by theory, it is believed that the halide salt improves the solubility of the zinc from the solution of cellulose or cellulose/protein in the coagulation bath thereby improving the mass transfer of zinc from the solution of cellulose or cellulose/protein into the coagulation bath.

The halide salt may be selected from, for example, zinc chloride, zinc bromide, zinc iodide, sodium chloride, sodium bromide, sodium iodide, potassium chloride, potassium bromide, potassium iodide, chloride salts of other metals, bromide salts of other metals, iodide salts of other metals and mixtures of any two or more thereof. In one embodiment, the halide salt is selected from zinc chloride, zinc bromide, zinc iodide, sodium chloride, sodium bromide, sodium iodide, potassium chloride, potassium bromide, potassium iodide and mixtures of any two or more thereof. Preferably, the halide salt is selected from potassium iodide, sodium bromide, zinc chloride and mixtures of any two or more thereof. More preferably, the halide salt is zinc chloride. Advantageously, the use of zinc chloride may provide more consistent fibres.

In one embodiment, the concentration of the halide salt in the coagulation bath is between about 1% w/v and about 60% w/v. The invention is not, however, limited thereto, and concentrations outside this range may also be useful. In one embodiment, the concentration of the halide salt in the coagulation bath is between about 10% w/v and about 50% w/v, for example, about 10% w/v, or about 15% w/v, or about 20% w/v, or about 25% w/v, or about 30% w/v, or about 35% w/v, or about 40% w/v, or about 45% w/v, or about 50% w/v. In one embodiment, the concentration of the halide salt in the coagulation bath is about 10% w/v. For example, the coagulation bath may comprise 10% w/v halide salt, such as 10% w/v potassium iodide or 10% w/v sodium bromide. In one embodiment, the concentration of zinc chloride in the coagulation bath is about 2% w/v.

The coagulation bath is typically maintained at a temperature of about 5° C. to about 15° C. Without wishing to be bound by theory, it is thought that extrusion within this temperature range forms the solid material without decomposition of the formate functionality.

Treatment of Extruded Solid Material with an Organic Solvent

The extruded solid material can be stabilised by treatment with an organic solvent to subsequently provide the cellulose-containing material or cellulose/protein-containing material. Advantageously, treating the extruded solid material with an organic solvent may subsequently provide the cellulose-containing material or cellulose/protein-containing material without requiring any additional stabilisation treatment, such as treating the extruded solid material with an oxidising solution or freezing the extruded solid material. However, the process for producing a cellulose-containing material or cellulose/protein-containing material may comprise two or more stabilisation treatments.

Accordingly, another aspect of the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with an organic solvent; and
(d) isolating the solid material from (c) to provide the cellulose-containing material.

Another aspect of the invention provides a process for producing a cellulose/protein-containing material comprising:
(a) contacting a cellulose source with a solvent comprising zinc ions and formic acid to provide a solution;
(b) contacting the solution from (a) with a protein source to provide a solution;
(c) extruding the solution from (b) into a coagulation bath to provide a solid material;
(d) treating the solid material from (c) with an organic solvent; and
(e) isolating the solid material from (d) to provide the cellulose/protein-containing material.

Another aspect of the invention provides a process for producing a cellulose/protein-containing material comprising:
(a) contacting a protein source with a solvent comprising zinc ions and formic acid to provide a solution;
(b) contacting the solution from (a) with a cellulose source to provide a solution;
(c) extruding the solution from (b) into a coagulation bath to provide a solid material;
(d) treating the solid material from (c) with an organic solvent; and
(e) isolating the solid material from (d) to provide the cellulose/protein-containing material.

Another aspect of the invention provides a process for producing a cellulose/protein-containing material comprising:
(a) contacting a cellulose source and a protein source with a solvent comprising zinc ions and formic acid to provide a solution;
(b) extruding the solution from (a) into a coagulation bath to provide a solid material;
(c) treating the solid material from (c) with an organic solvent; and
(d) isolating the solid material from (d) to provide the cellulose/protein-containing material.

The organic solvent is preferably a volatile organic solvent, such as methyl formate, ethyl formate, ethyl acetate, acetone or ethyl alcohol. More preferably, the solvent is a volatile ester solvent. More preferably, the solvent is selected from methyl formate and ethyl formate.

The organic solvent may be substantially anhydrous or may comprise water. For example, the solvent may comprise water in an amount between about 1% w/v and about 95% w/v, such as about 1% w/v, or about 2% w/v, or about 5% w/v, or about 10% w/v, or about 20% w/v, or about 30% w/v, or about 40% w/v, or about 50% w/v, or about 60% w/v, or about 70% w/v, or about 80% w/v, or about 90% w/v, or about 95% w/v.

In one embodiment, the solvent is about 98-100% w/v methyl formate. In another embodiment, the solvent is about 98-100% w/v ethyl formate. In another embodiment the solvent is about 30% w/v aqueous methyl formate. In another embodiment the solvent is about 20% w/v aqueous methyl formate. In another embodiment, the solvent is about 9% w/v aqueous ethyl formate.

The extruded solid material may be treated during or immediately after isolation of the solid material. Preferably, the extruded solid material is treated before drying. For example, extruded fibres prepared by a process of the present invention may be rinsed with, or immersed in, an organic solvent during and/or immediately after a spinning process.

The treated extruded solid material may then be dried to provide a cellulose-containing material or cellulose/protein-containing material. For example, the solid material may be air dried at ambient (room) temperature, typically about 20° C. to about 25° C. or at elevated temperature. Those persons skilled in the art will appreciate that the drying time will depend on, for example, the choice of organic solvent and the drying temperature.

Treatment of Extruded Solid Material with a Reducing Agent

The extruded solid material can be stabilised by treatment with a reducing agent, to subsequently provide the cellulose-containing material or cellulose/protein-containing material. Advantageously, treating the extruded solid material with reducing agent may subsequently provide the cellulose-containing material or cellulose/protein-containing material without requiring any additional stabilisation treatment, such as treating the extruded solid material with an oxidising solution or freezing the extruded solid material. However, the process for preparing a cellulose-containing material or cellulose/protein-containing material may comprise two or more stabilisation treatments. Additionally, treating the extruded solid material with a reducing agent may subsequently provide a cellulose-containing material or cellulose/protein-containing material having more cellulose-like characteristics. For example, a cellulose-containing material or cellulose/protein-containing material having more cellulose-like tactile properties. Without wishing to be bound by theory, it is thought that treating with a reducing agent may remove the formate groups from the material and consequently regenerate cellulose and/or produce cellulose monoformate.

Accordingly, another aspect of the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with a reducing agent; and
(d) isolating the solid material from (c) to provide the cellulose-containing material.

Another aspect of the invention provides a process for producing a cellulose/protein-containing material comprising:
(a) contacting a cellulose source with a solvent comprising zinc ions and formic acid to provide a solution;
(b) contacting the solution from (a) with a protein source to provide a solution;
(c) extruding the solution from (b) into a coagulation bath to provide a solid material;
(d) treating the solid material from (c) with a reducing agent; and
(e) isolating the solid material from (d) to provide the cellulose/protein-containing material.

Another aspect of the invention provides a process for producing a cellulose/protein-containing material comprising:
(a) contacting a protein source with a solvent comprising zinc ions and formic acid to provide a solution;
(b) contacting the solution from (a) with a cellulose source to provide a solution;
(c) extruding the solution from (b) into a coagulation bath to provide a solid material;
(d) treating the solid material from (c) with a reducing agent; and
(e) isolating the solid material from (d) to provide the cellulose/protein-containing material.

Another aspect of the invention provides a process for producing a cellulose/protein-containing material comprising:
(a) contacting a cellulose source and a protein source with a solvent comprising zinc ions and formic acid to provide a solution;
(b) extruding the solution from (a) into a coagulation bath to provide a solid material;
(c) treating the solid material from (c) with a reducing agent; and
(d) isolating the solid material from (d) to provide the cellulose/protein-containing material.

The reducing agent may be any suitable reducing agent known to those persons skilled in the art. For example, the reducing agent may be selected from sodium sulfite, sodium sulfide, sodium metabisulfite, sodium borohydride, sodium hydrogen sulfide and mixtures of any two or more thereof. Preferably, the reducing agent is sodium hydrogen sulfide. The reducing agent is typically used as a solution in a solvent. Preferably, the reducing agent is used as an aqueous solution. Accordingly, in one embodiment, the extruded solid material is treated with a solution comprising about 10% w/v sodium hydrogen sulfide. In another embodiment, the extruded solid material is treated with a solution comprising about 10% w/v sodium bisulfite. In another embodiment, the extruded solid material is treated with a solution comprising about 10% w/v sodium metabisulfite.

The extruded solid material may be immersed in a solution comprising a reducing agent for about 1 minute to about 24 hours. In one embodiment, the extruded solid material is immersed in a solution comprising a reducing agent for about 1 minute, or about 2 minutes, or about 3 minutes, or about 4 minutes, or about 5 minutes, or about 10 minutes, or about 30 minutes, or about 1 hour, or about 2 hours, or about 3 hours, or about 4 hours, or about 5 hours, or about 6 hours, or about 7 hours, or about 8 hours, or about 9 hours, or about 10 hours, or about 11 hours, or about 12 hours, or about 13 hours, or about 14 hours, or about 15 hours, or about 16 hours, or about 17 hours, or about 18 hours, or about 19 hours, or about 20 hours, or about 21 hours, or about 22 hours, or about 23 hours, or about 24 hours. For example, in one embodiment, the extruded solid material is immersed in a solution comprising sodium bisulfite or sodium metabisulfite for about 24 hours. In another embodiment, the extruded solid material is immersed in a solution comprising sodium bisulfite or sodium metabisulfite for about 10 hours. In another embodiment, the extruded solid material is immersed in a solution comprising sodium hydrogen sulfide for about 1 hour. Shorter or longer immersion times may, however, still be useful.

The extruded solid material may be immersed in a solution comprising a reducing agent at room temperature or above. Lower temperatures may, however, still be useful. In one embodiment, the solution comprising the reducing agent is at a temperature of at least about 20° C., or at least about 25° C., or at least about 30° C., or at least about 35° C., or at least about 40° C., or at least about 45° C., or at least about 50° C., or at least about 55° C., or at least about 60° C., or at least about 65° C., or at least about 70° C., or at least about 75° C., or at least about 80° C., or at least about 85° C., or at least about 90° C., or at least about 95° C., or about 100° C. In one embodiment, the solution is at a temperature of about 20° C., or about 25° C., or about 30° C., or about 35° C., or about 40° C., or about 45° C., or about 50° C., or about 55° C., or about 60° C., or about 65° C., or about 70° C., or about 75° C., or about 80° C., or about 85° C., or about 90° C., or about 95° C., or about 100° C. In one embodiment, the solution is at a temperature of at least about 95° C., or at least about 96° C., or at least about 97° C., or at least about 98° C., or at least about 99° C., or about 100° C. In one embodiment, the solution is at a temperature of about 95° C., or about 96° C., or about 97° C., or about 98° C., or about 99° C., or about 100° C. In one embodiment, the solution is at room temperature and the extruded solid material is immersed for about 24 hours.

Advantageously, the extruded solid material may be immersed in a solution comprising a reducing agent for a shorter period of time when the solution temperature is above room temperature. For example, the extruded solid material may be immersed in a solution at a temperature of at least about 95° C. for a period of at least about 2 minutes. In one embodiment, the temperature is about 95° C. and the extruded solid material is immersed for about 2 minutes. The extruded solid material may be treated with a reducing agent before and/or after being isolated and dried. For example, the extruded solid material may be passed through a solution comprising a reducing agent immediately following extrusion into the coagulation bath. Alternatively, the extruded solid material may be isolated, optionally dried, and immersed in a solution comprising a reducing agent.

After treatment with a reducing agent, the solid material is removed from the solution and optionally rinsed in a solvent, such as water. The solid material is then dried. For example, the solid material may be air dried at ambient (room) temperature, typically about 20° C. to about 25° C. or at elevated temperature.

### Treatment of Extruded Solid Material in Water at an Elevated Temperature

The extruded solid material can be stabilised by treatment in water at an elevated temperature, preferably at a temperature of at least about 95° C., to subsequently provide the cellulose-containing material or cellulose/protein-containing material. Advantageously, treating the extruded solid material in water at an elevated temperature may subsequently provide the cellulose-containing material or cellulose/protein-containing material without requiring any additional stabilisation treatment. However, the process for preparing a cellulose-containing material or cellulose/protein-containing material may comprise two or more stabilisation treatments. Additionally, treating the extruded solid material in water at an elevated temperature may subsequently provide a cellulose-containing material or cellulose/protein-containing material having more cellulose-like characteristics. For example, a cellulose-containing material or cellulose/protein-containing material having more cellulose-like tactile properties. Without wishing to be bound by theory, it is thought that treating the extruded material in water at an elevated temperature, preferably at a temperature of at least about 95° C. may remove the formate groups from the material and consequently regenerate cellulose and/or produce cellulose monoformate.

Accordingly, another aspect of the invention provides a process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) in water at a temperature of at least about 95° C.; and
(d) isolating the solid material from (c) to provide the cellulose-containing material.

Another aspect of the invention provides a process for producing a cellulose/protein-containing material comprising:
(a) contacting a cellulose source with a solvent comprising zinc ions and formic acid to provide a solution;
(b) contacting the solution from (a) with a protein source to provide a solution;
(c) extruding the solution from (b) into a coagulation bath to provide a solid material;
(d) treating the solid material from (c) in water at a temperature of at least about 95° C.; and
(e) isolating the solid material from (d) to provide the cellulose/protein-containing material.

Another aspect of the invention provides a process for producing a cellulose/protein-containing material comprising:
(a) contacting a protein source with a solvent comprising zinc ions and formic acid to provide a solution;
(b) contacting the solution from (a) with a cellulose source to provide a solution;
(c) extruding the solution from (b) into a coagulation bath to provide a solid material;
(d) treating the solid material from (c) in water at a temperature of at least about 95° C.; and
(e) isolating the solid material from (d) to provide the cellulose/protein-containing material.

Another aspect of the invention provides a process for producing a cellulose/protein-containing material comprising:
(a) contacting a cellulose source and a protein source with a solvent comprising zinc ions and formic acid to provide a solution;
(b) extruding the solution from (a) into a coagulation bath to provide a solid material;
(c) treating the solid material from (c) in water at a temperature of at least about 95° C.; and
(d) isolating the solid material from (d) to provide the cellulose/protein-containing material.

The extruded solid material may be immersed in water at an elevated temperature for about 1 minute to about 24 hours. In one embodiment, the water is at a temperature of at least about 95° C., or at least about 96° C., or at least about 97° C., or at least about 98° C., or at least about 99° C., or about 100° C. In one embodiment, the water is at a temperature of about 95° C., or about 96° C., or about 97° C., or about 98° C., or about 99° C., or about 100° C. In one embodiment, the extruded solid material is immersed in water at an elevated temperature for about 1 minute, or about 2 minutes, or about 3 minutes, or about 4 minutes, or about 5 minutes, or about 10 minutes, or about 30 minutes, or about 1 hour, or about 2 hours, or about 3 hours, or about 4 hours, or about 5 hours, or about 6 hours, or about 7 hours, or about 8 hours, or about 9 hours, or about 10 hours, or about 11 hours, or about 12 hours, or about 13 hours, or about 14 hours, or about 15 hours, or about 16 hours, or about 17 hours, or about 18 hours, or about 19 hours, or about 20 hours, or about 21 hours, or about 22 hours, or about 23 hours, or about 24 hours. For example, in one embodiment, the extruded solid material is immersed in water at a temperature of at least about 95° C. for a period of at least about 2 minutes. In one embodiment, the extruded solid material is immersed in water at a temperature of about 95° C. for about 2 minutes.

In one embodiment, the extruded solid material is immersed in substantially pure water at a temperature of at least about 95° C.

The extruded solid material may be treated in water at an elevated temperature before and/or after being isolated and dried. For example, the extruded solid material may be treated in water at an elevated temperature immediately following extrusion into the coagulation bath. Alternatively, the extruded solid material may be isolated, optionally dried, and immersed in water at an elevated temperature.

After treatment in water at an elevated temperature, the solid material is removed from the liquid and optionally rinsed in a solvent, such as water. The solid material is then dried. For example, the solid material may be air dried at ambient (room) temperature, typically about 20° C. to about 25° C. or at elevated temperature.

### Freeze-Thaw Cycle Treatment of Cellulose-Containing Solution and Cellulose/Protein Containing Solution

A stabilised extruded solid material may also be obtained by freezing the solution comprising dissolved cellulose prior to the extrusion step, to subsequently provide the cellulose-containing material or cellulose/protein-containing material. Advantageously, freezing the solution comprising dissolved cellulose may subsequently provide the cellulose-containing material or cellulose/protein-containing material without requiring any additional stabilisation treatment, such as treating the extruded solid material with an oxidising solution or freezing the extruded solid material. However, the process for preparing a cellulose-containing material or cellulose/protein-containing material may comprise two or more stabilisation treatments.

Accordingly, another aspect of the invention provides a process for producing a cellulose-containing material comprising:
(a) contacting a cellulose source with a solvent comprising zinc ions and formic acid to provide a solution;
(b) freezing and then thawing the solution from (a) to provide a thawed solution;
(c) extruding the thawed solution from (b) into a coagulation bath to provide a solid material; and
(d) isolating the solid material from (c) to provide the cellulose-containing material.

Another aspect of the invention provides a process for producing a cellulose/protein-containing material comprising:
(a) contacting a cellulose source with a solvent comprising zinc ions and formic acid to provide a solution;
(b) contacting the solution from (a) with a protein source to provide a solution;
(c) freezing and then thawing the solution from (b) to provide a thawed solution;
(d) extruding the thawed solution from (c) into a coagulation bath to provide a solid material; and
(e) isolating the solid material from (d) to provide the cellulose/protein-containing material.

Another aspect of the invention provides a process for producing a cellulose-containing material comprising:
(a) contacting a cellulose source with a solvent comprising zinc ions and formic acid to provide a solution;
(b) freezing and then thawing the solution from (a) to provide a thawed solution;
(c) contacting the thawed solution from (b) with a protein source to provide a solution;
(d) extruding the solution from (c) into a coagulation bath to provide a solid material; and

(e) isolating the solid material from (c) to provide the cellulose-containing material.

Another aspect of the invention provides a process for producing a cellulose/protein-containing material comprising:
(a) contacting a protein source with a solvent comprising zinc ions and formic acid to provide a solution;
(b) contacting the solution from (a) with a cellulose source to provide a solution; material.
(c) freezing and then thawing the solution from (b) to provide a thawed solution;
(d) extruding the thawed solution from (c) into a coagulation bath to provide a solid material; and
(e) isolating the solid material from (c) to provide the cellulose/protein-containing material.

Another aspect of the invention provides a process for producing a cellulose/protein-containing material comprising:
(a) contacting a cellulose source and a protein source with a solvent comprising zinc ions and formic acid to provide a solution;
(b) freezing and then thawing the solution from (a) to provide a thawed solution;
(c) extruding the thawed solution from (b) into a coagulation bath to provide a solid material; and
(d) isolating the solid material from (c) to provide the cellulose/protein-containing material.

The solution comprising dissolved cellulose and optionally dissolved protein is frozen. For example, the solution may be held in an environment at about −20° C. until frozen solid. In one embodiment, the solution is frozen for at least 2 hours. Preferably, the solution is frozen for about 24 hours. Shorter or longer freezing times may, however, still be useful.

In a preferred embodiment, the frozen solution is thawed at a temperature of about 5° C. to about 30° C. Temperatures outside this range may, however, still be useful. Advantageously, the frozen solution may be thawed at ambient (room) temperature, typically about 20° C. to about 25° C.

### Freeze-Thaw Cycle or Freeze Drying Treatment of Extruded Solid Material

As an optional stabilisation treatment, the extruded solid material may be soaked in water and then frozen, to subsequently provide the cellulose-containing material or cellulose/protein-containing material.

Typically, the solid material is immersed in water for about 1 to about 90 minutes. Immersion times outside this range may, however, still be useful. Preferably, the immersion time is about 30 minutes.

After immersion of the solid material in water, the solution in which the solid material is immersed is frozen. For example, the solution may be held in an environment at about −20° C. until frozen solid. In one embodiment, the solution is frozen for at least 2 hours.

The solid material is then isolated to provide the cellulose-containing material or cellulose/protein-containing material. In one embodiment, the solid material is isolated by freeze drying to provide the cellulose-containing material or cellulose/protein-containing material. In another embodiment, the frozen water is thawed, and the solid material removed from the thawed water, then dried to provide the cellulose-containing material or cellulose/protein-containing material.

In a preferred embodiment, the water is thawed at a temperature of about 5° C. to about 30° C. Temperatures outside this range may, however, still be useful. Advantageously, the water may be thawed at ambient (room) temperature, typically about 20° C. to about 25° C.

After removal of the solid material from the thawed water, it may be air dried at ambient (room) temperature, typically about 20° C. to about 25° C., to provide the cellulose-containing material or cellulose/protein-containing material. Preferably, the use of a heat source is avoided during air drying of the solid material.

Treatment of Extruded Solid Material with an Oxidising Solution

Optionally, in some embodiments it may be advantageous to treat the extruded solid material an oxidising solution, to subsequently provide the cellulose-containing material or cellulose/protein-containing material.

Accordingly, the solid material may be immersed in an oxidising solution. A preferred oxidising solution comprises aqueous hydrogen peroxide. However, the invention is not limited thereto and other oxidising solutions, including water comprising a sufficient amount of dissolved oxygen, can be used. For example, water through which air or oxygen has been passed, such that it is saturated with dissolved oxygen.

In one embodiment, the oxidising solution comprises about 0.5% w/w to about 5.0% w/w hydrogen peroxide in water. In another embodiment, the oxidising solution comprises about 0.5% w/w to about 1.0% w/w hydrogen peroxide in water. In another embodiment, the oxidising solution comprises about 0.7% w/w hydrogen peroxide in water. For example, a suitable oxidising solution may be prepared by mixing 2% w/v of 35% w/w hydrogen peroxide with water.

Typically, the solid material is immersed in the oxidising solution for about 1 to about 5 minutes. Immersion times outside this range may, however, still be useful.

After immersion of the solid material in the oxidising solution, the oxidising solution in which the solid material is immersed is frozen. For example, the solution may be held in an environment at about −20° C. until frozen solid. In one embodiment, the solution is frozen for at least about 2 hours.

The solid material is then isolated to provide the cellulose-containing material or cellulose/protein-containing material. In one embodiment, the solid material is isolated by freeze drying to provide the cellulose-containing material or cellulose/protein-containing material. In another embodiment, the frozen solution is thawed, and the solid material removed from the thawed solution, then dried to provide the cellulose-containing material or cellulose/protein-containing material.

In a preferred embodiment, the frozen solution is thawed at a temperature of about 5° C. to about 30° C. Temperatures outside this range may, however, still be useful. Advantageously, the frozen solution may be thawed at ambient (room) temperature, typically about 20° C. to about 25° C.

After removal of the solid material from the thawed solution, it may be air dried at ambient (room) temperature, typically about 20° C. to about 25° C., to provide the cellulose-containing material or cellulose/protein-containing material. Preferably, the use of a heat source is avoided during air drying of the solid material.

Without wishing to be bound by theory, it is thought the oxidising solution may convert the formate substituents to performate substituents. The performate substituents may then rearrange to carbonate and either the performate substituents or carbonate are removed by the subsequent freeze-thaw cycle, or freeze drying. The evaporation of the released formic acid during the process of the present invention is thought to stabilise the cellulose-containing material or cellulose/protein-containing material.

Treatment of Extruded Solid Material with Formate Salt

As a further optional stabilisation treatment, the extruded solid material may be soaked in an aqueous formate salt solution to subsequently provide the cellulose-containing material or cellulose/protein-containing material. The coagulation bath may comprise a soluble formate salt, as described above. However, the aqueous formate salt solution in which the solid material is soaked is typically a different solution. For example, the solid material from the coagulation bath may be immersed in an aqueous formate salt solution. Preferably, the concentration of formate salt in the aqueous formate salt solution is higher than that in the coagulation bath.

Preferably, the formate salt is selected from sodium formate, potassium formate, ammonium formate or a mixture of any two or more thereof. In one embodiment, the aqueous formate salt solution is an aqueous solution of sodium formate. In another embodiment, the aqueous formate salt solution is an aqueous solution of potassium formate. In another embodiment, the aqueous formate salt solution is an aqueous solution of ammonium formate.

The concentration of formate salt in the aqueous formate salt solution is typically between about 20% w/v and about 60% w/v. Preferably, the concentration of formate salt is between about 45% w/v and about 55% w/v. More preferably, the concentration of formate salt is about 50% w/v.

In one embodiment, the solid material is immersed in the aqueous formate salt solution for up to about 16 hours. Shorter or longer immersion times may, however, still be useful. Preferably, the solid material is immersed in the aqueous formate salt solution for up to about 30 to about 90 minutes, more preferably about 60 minutes.

After immersion in the aqueous formate salt solution, the solid material is removed from the solution and dried. For example, the solid material may be air dried at ambient (room) temperature, typically about 20° C. to about 25° C. or at elevated temperature. Preferably, the solid material is air dried at a temperature of about 45° C.

During drying, a residue of solid formate salt forms on the surface of the solid material. Without wishing to be bound by theory, it is thought that any residual formic acid in the solid material is drawn to the solid formate salt on the surface, therefore removing it from the solid material.

After drying, the solid material is rinsed in water. The solid material may then be air dried at ambient (room) temperature, typically about 20° C. to about 25° C. or at elevated temperature, to provide the cellulose-containing material or cellulose/protein-containing material. Preferably, the solid material is air dried at a temperature of about 45° C.

### Materials Comprising Cellulose and Cellulose/Protein

The process of the present invention provides a product that can be continuous and have a form or profile controlled by the extrusion process. In contrast, the cellulose source is not continuous and the materials used as the cellulose source typically have a form or profile determined by the growth of a plant. Similar considerations apply to the protein source.

For example, the process of the invention can be used to produce cellulose/casein fibres that are flexible and fine.

Another aspect of the present invention relates to a cellulose-containing material or cellulose/protein-containing material produced by a process of the invention.

Another aspect of the present invention relates to an extruded material comprising cellulose and protein. The present invention also relates to a substantially continuous material comprising cellulose and protein.

In one embodiment, the material consists essentially of cellulose and protein. In another embodiment, the material consists of cellulose and protein.

The material may be a fibre or a film.

Preferred materials have a protein content of about 5% w/w or more.

The protein may comprise keratin. Preferably, the keratin is wool keratin.

The cellulose may be derived from, for example, cotton, wood pulp or plant parts. The material may comprise one or more pigments and/or one or more fragrances from the plant parts.

Another aspect of the invention relates to an extruded material comprising cellulose and one or more pigments and/or one or more fragrances from plant parts. Another aspect of the invention relates to a substantially continuous material comprising cellulose and one or more pigments and/or one or more fragrances from plant parts.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

The following non-limiting examples are provided to illustrate the present invention and in no way limit the scope thereof.

### EXAMPLES

### Example 1—Dissolution of Cellulose in Zinc Formate/Formic Acid

### Part A—Preparation of Anhydrous Zinc Formate

20 grams anhydrous zinc chloride was dissolved in 50 ml water. Excess solid sodium carbonate was slowly added to this solution until gas evolution ceased. The resulting precipitate was filtered and rinsed with water to remove excess salts, including sodium chloride. The precipitate was dried at room temperature and excess 98% formic acid was added to the precipitate until gas evolution ceased. The resulting precipitate of zinc formate dihydrate was filtered and dried at room temperature. This was found to be insoluble in 98% formic acid. Zinc formate dihydrate was converted to anhydrous zinc formate through heating at 95° C. until a constant weight was achieved, approximately 30 minutes. The resulting anhydrous zinc formate was soluble in 98% formic acid.

### Part B—Dissolution of Cellulose

40 grams of anhydrous zinc formate was dissolved in 100 ml 98% formic acid. 2 grams of cotton, a source of native cellulose with a high degree of polymerisation, was added to the solution and the resulting mixture stirred for 9 hours to provide a solution.

Alternatively, 5 grams of cotton was added to the zinc formate/formic acid solution and the resulting mixture stirred for 9 hours to provide a more concentrated solution.

### Example 2—Dissolution of Cellulose in Zinc Bromide/Formic Acid

40 grams of zinc bromide was dissolved in 100 ml of 98% formic acid. After 1 hour, all of the salt had dissolved and the solution was heated to 80° C. and hydrogen bromide gas evolved. Once evolution of hydrogen bromide gas ceased, the solution was cooled to 15° C. and 2 grams of cotton, a source of native cellulose with a high degree of polymerisation, was dissolved in the mixture.

### Example 3—Dissolution of Cellulose in Zinc Formate/Formic Acid

### Part A—Preparation of Anhydrous Zinc Formate

40 grams of anhydrous zinc chloride was dissolved in 100 ml of 98% formic acid. After 1 hour, all of the salt had dissolved and the solution was heated to 80° C. and hydrogen chloride gas evolved. The solution was evaporated to dryness to remove the formic acid and water present, resulting in anhydrous zinc formate.

### Part B—Dissolution of Cellulose

20 grams of the resulting solid was dissolved in 50 ml of 98% formic acid and 1 gram of cotton, a source of native cellulose with a high degree of polymerisation, was dissolved in the mixture.

### Example 4—Dissolution of Plant Parts

2 grams of dehydrated rose flower petals were prepared by drying rose petals following collection. 40 grams of anhydrous zinc formate, prepared as outlined in Part A of Example 1, was dissolved in 100 ml of 98% formic acid. The dehydrated rose flower petals were added to the solution along with 2 grams of wood pulp, a source of cellulose with a high degree of polymerisation, and the mixture stirred for 9 hours to achieve complete dissolution. The resulting solution retained the colour and fragrance of the rose petals.

Solvent systems using zinc bromide and zinc chloride, as described in Examples 3 and 4, were similarly utilised with the combination of dehydrated rose petals and wood pulp to provide rose coloured solutions that retained the rose fragrance.

### Example 5—Dissolution of Wool in Zinc Chloride/Formic Acid

10 grams of anhydrous zinc chloride was added to 20 ml of 98% formic acid and the solution stirred till clear. 10 grams of cysteine was added and the solution stirred for an hour until clear. 3 grams of clean, dry, crossbred wool was added and the mixture stirred for a further 5-8 hours at 35° C. 100 ml of water was added to the stirred solution, causing a precipitate to form. The precipitate was isolated by filtration and dried. The resulting dried keratin formate was further dissolved in 98% formic acid to form a solution of keratin formate.

### Example 6—Dissolution of Silk or Casein in Zinc Formate or Zinc Bromide/Formic Acid

The dissolution methods described in Examples 1-3 were used to separately dissolve silk or casein. Substitution of the cellulose by either 20 grams of silk per 100 ml of 98% formic acid or 40-60 grams of casein per 100 ml of formic acid and following the procedures as described in Examples 1-3 gave solutions of either silk or casein.

### Example 7—Dissolution of Cellulose and Keratin Protein Powder in Zinc Chloride/Formic Acid

80 grams of anhydrous zinc chloride was added to 200 ml of 98% formic acid and the solution was stirred with an overhead stirrer at 200 rpm for 1 hour. 14 grams (7% w/v) of cotton linters, a source of native cellulose with a high degree of polymerisation, was then added to the solution and the mixture was left to soak for 1.5 hours. The mixture was then stirred with an overhead stirrer at 50 rpm at a temperature of 25° C. After the mixture had been stirring for 18.5 hours, 8.58 grams of keratin protein powder prepared according to the methods described in WO 2013/43062 was added to mixture. The keratin protein powder was initially mixed into the mixture by hand using a metal spatula to ensure the powder was well dispersed. Overhead stirring of the keratin protein powder/cellulose mixture at 50 rpm was continued for 4 hours at a temperature of 25° C.

### Example 8—Extrusion of Keratin Protein/Cellulose Formate Fibres

The solution of Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath, passed through a water rinse bath at 30° C. and transferred to a bobbin. The wet bobbin of fibres was frozen within water to form a solid ice block. The ice block was then allowed to thaw at room temperature and the resulting wet fibres allowed to dry at room temperature. Alternatively, the wet bobbin of fibres was frozen as-collected (i.e., with residual water from the rinse bath) and then allowed to thaw and dry at room temperature.

### Example 9—Alternative Extrusion of Keratin Protein/Cellulose Formate Fibres: Modified Coagulation Baths

A solution prepared according to Example 7 was transferred into a syringe and pumped using a syringe pump through a spinneret, consisting of 200 holes, each of 100 micron diameter, into a 10 litre coagulation bath containing 2% w/v aqueous zinc chloride at 10° C. The extruded fibres were collected on a driven take up roller from the coagulation bath, passed through a water rinse bath at 30° C. and transferred to a bobbin. The wet bobbin of fibres was frozen within water to form a solid ice block. The ice block was then allowed to thaw at room temperature and the resulting wet fibres allowed to dry at room temperature. Alternatively, the wet bobbin of fibres was frozen as-collected (i.e., with residual water from the rinse bath) and then allowed to thaw and dry at room temperature.

The process was repeated using a coagulation bath containing 2% w/v aqueous sodium bromide or 2% w/v aqueous potassium iodide.

### Example 10—Alternative Extrusion of Keratin Protein/Cellulose Formate Fibres: Pre-Extrusion Freeze-Thaw Cycle

As an alternative to Example 8, a solution prepared according to Example 7 was placed in a freezer at −20° C. and kept frozen for 24 hours. Subsequently, the solution was thawed, extruded into a 10 litre coagulation bath containing water at 10° C. and spun into fibres using a vertical wet-spinning set up. The resulting fibres were collected on a bobbin and dried without the freeze-thaw processing detailed in Example 8. Advantageously, the fibres obtained by this method were found to be stable at room temperature without further treatment.

### Example 11—Alternative Extrusion of Keratin Protein/Cellulose Formate Fibres: Post-Treatment of Fresh-Spun Fibres by Freeze Drying

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath, passed through a water rinse bath at 30° C. and transferred to a bobbin. The wet bobbin of fibres was frozen within water to form a solid ice block. The ice block with fibres was then put into a freeze drying machine at −50° C. and pressure 0.045 mBar.

Solid state ¹³C NMR spectroscopy was performed on the fibres. Cellulose carbon is identified by peaks occurring in the region around 60-110 ppm. Cellulose formate is identified by a single peak in the region 170-180 ppm. Fibres prepared by any of the methods of Examples 8-10 showed a peak in the region 170-180 ppm, indicating the presence of the formate group. Fibres prepared by the method described in this Example showed no peak in this region, indicating that the formate group was absent. The ¹³C NMR spectrum was consistent with native cellulose without derivatisation.

The resultant fibres were insoluble in formic acid and dimethyl sulfoxide, which is thought to indicate that the fibres had been converted to cellulose and/or cellulose monoformate. Accordingly, while the freeze-thaw process of Example 8 is thought to stabilise cellulose formate fibres, the freeze drying process of this Example surprisingly appeared to regenerate cellulose fibres.

### Example 12A—Post-Treatment of Fibres with Methyl Formate

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath, passed through a water rinse bath at 30° C. and transferred to a bobbin. 2 metres of fresh-spun wet fibres were steeped in 25 ml of methyl formate (98-100% w/v, pure analytical grade) in a beaker. The solvent was left to evaporate at room temperature under a fume-hood. The fibres were dry after 5 hours.

The process was repeated using ethyl formate (98-100% w/v, pure analytical grade), instead of methyl formate.

In each case, the dried fibres were stable, did not decompose into a gel and did not stick to each other.

### Example 12B—Post-Treatment of Fibres with 20% w/v Methyl Formate

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath, passed through a water rinse bath at 30° C. and transferred to a bobbin. The bobbin of fresh-spun wet fibres was steeped in 2 litres of 20% w/v aqueous methyl formate, in a beaker and left in the solution for 2 hours. The bobbin was subsequently left to dry at room temperature for 2 hours.

The process was repeated using 9% w/v aqueous ethyl formate instead of aqueous methyl formate.

In each case, the dried fibres were stable, did not decompose into a gel and did not stick to each other.

### Example 13A—Post-Treatment of Fresh-Spun Fibres with Reducing Agent

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath and passed through a water rinse bath at 30° C. 2 meters of fresh-spun fibres were steeped into 100 ml of a 10% w/v solution of sodium hydrogen sulfide for 24 hours at room temperature. Subsequently, the fibres were rinsed in water and dried at room temperature for 24 hours.

Four alternative processes were also performed. In one alternative, the 10% sodium hydrogen sulfide solution was replaced with a 10% sodium bisulfite solution. In another alternative, the 10% sodium hydrogen sulfide solution was replace with a 10% sodium metabisulfite solution. In another alternative, the 10% sodium hydrogen sulfide solution was replaced with a 10% sodium sulfite solution. In yet another alternative, the fresh-spun fibres were steeped for at least 2 minutes at a temperature of 95° C. instead of for 24 hours at room temperature.

In each case, the resultant fibres were insoluble in formic acid and dimethyl sulfoxide, which is thought to indicate that the fibres had been converted to cellulose and/or cellulose monoformate.

Solid state ¹³C NMR spectroscopy was performed on the resultant fibres. The ¹³C NMR spectrum showed no formyl peak, further indicating that treatment with the reducing agent had regenerated cellulose.

### Example 13B—Post-Treatment of Dry Fibres with Reducing Agent

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath, passed through a water rinse bath at 30° C. and transferred to a bobbin. The wet bobbin of fibres was frozen within water to form a solid ice block. The ice block was then allowed to thaw at room temperature and the resulting wet fibres allowed to dry at room temperature. 2 grams of dry fibres were steeped in 100 ml of 10% w/v aqueous sodium hydrogen sulfide for 24 hours. Subsequently, the fibres were rinsed in water and dried.

The process was repeated using 10% w/v aqueous sodium bisulfite. or 10% aqueous sodium hydrogen sulfide was replace with a 10% w/v aqueous sodium metabisulfite.

In each case, the resultant fibres were insoluble in formic acid and dimethyl sulfoxide, which is thought to indicate that the fibres had been converted to cellulose and/or cellulose monoformate.

Solid state ¹³C NMR spectroscopy was performed on the resultant fibres. The ¹³C NMR spectrum showed no formyl peak, further indicating that treatment with the reducing agent had regenerated cellulose.

### Example 14—Post-Treatment of Fresh-Spun Fibres with Hot Water

A solution prepared according to Example 7 was transferred into a syringe and pumped using a syringe pump through a spinneret, consisting of 200 holes, each of 100 micron diameter, into a coagulation bath consisting of water at 10° C. The extruded fibres were collected on a driven take up roller from the coagulation bath and passed through a water rinse bath at 30° C. 2 meters of fresh-spun fibres were steeped in 100 ml of water at 95° C. for at least 2 minutes. Subsequently, the fibres were rinsed in water and dried at room temperature for 24 hours.

The resultant fibres were insoluble in formic acid and dimethyl sulfoxide, which is thought to indicate that the fibres had been converted to cellulose and/or cellulose monoformate.

Solid state ¹³C NMR spectroscopy was performed on the resultant fibres. The ¹³C NMR spectrum showed no formyl peak, further indicating that treatment with the water at 95° C. had regenerated cellulose.

### Example 15A—Isolation of Cellulose Formate Intermediate from Zinc/Formic Acid Solution

1.8 grams of cotton linters and 0.20 grams of wood pulp were added to a 100 ml solution of 40% w/v anhydrous zinc chloride in 98% formic acid and steeped for 24 hours. The solution was then stirred for an hour and 300 ml of water was added to the solution. Cellulose formate precipitated from the solution as solidified lumps. The solidified lumps were collected on a sieve and rinsed with water. The solidified lumps were immersed in 200 ml water and placed in a freezer at −20° C. for 24 hours. The ice block containing water was then allowed to thaw at room temperature and the resulting lumps dried at room temperature for 24 hours. The dried lumps of cellulose formate weighed approximately 3.5 grams.

### Example 15B—Extrusion with Isolated Cellulose Formate and 98% Formic Acid

10 grams of dried lumps of cellulose formate prepared by a process according to Example 15A were ground to provide cellulose formate powder. The powder was dissolved in 100 ml of 98% formic acid and stirred for 2 hours. The solution was then extruded into a 1 litre coagulation bath consisting of water at 10° C. and spun into fibres using wet spinning equipment. Fibres were collected and frozen in 50 ml of water at −20° C. for 24 hours. The fibres were thawed and dried at room temperature.

### Example 15C—Extrusion with Isolated Cellulose Formate and 99% Dimethyl Sulfoxide

10 grams of dried lumps of cellulose formate prepared by a process according to Example 15A were ground to provide cellulose formate powder. The powder was dissolved in 100 ml of 99% dimethyl sulfoxide and stirred for 2 hours. The solution was then extruded into a 1 litre coagulation bath consisting of water at 10° C. and spun into fibres using wet spinning equipment. Fibres were collected and frozen in 50 ml of water at −20° C. for 24 hours. Finally, fibres were thawed and dried at room temperature.

### INDUSTRIAL APPLICATION

It will be appreciated from the discussion above that the present invention provides a process for the production of cellulose-containing and cellulose/protein-containing materials. The materials can be produced in the form of, for example, fibres or films, the dimensions of which are independent of the dimensions of the cellulose and/or protein source material. When produced in the form of fibres, the materials may be useful in, for example, textiles.

Those persons skilled in the art will understand that the above description is provided by way of illustration only and that the invention is not limited thereto. Many variations are possible without departing from the scope of the invention as set out in the accompanying claims.

### REFERENCES

The entire content of each of the following documents is incorporated herein by reference:
CN 105153316
US 2014/0090640
GB 260650
GB 275641
U.S. Pat. No. 4,839,113
GB 690566
U.S. Pat. No. 7,465,321
WO 2013/043062
WO 2020/060419.

1. A process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with a reducing agent; and
(d) isolating the solid material from (c) to provide the cellulose-containing material.

2. The process of claim 1, wherein the reducing agent is selected from sodium sulfite, sodium sulfide, sodium metabisulfite, sodium borohydride, sodium hydrogen sulfide and mixtures of any two or more thereof.

3. The process of claim 1 or 2, wherein the solid material is immersed in a reducing agent solution for between about 1 minute and about 24 hours.

4. The process of any one of claims 1-3, wherein the solid material is immersed in a reducing agent solution at a temperature of at least about 95° C.

5. The process of any one of claims 1-4, wherein the solid material is immersed in a reducing agent solution at a temperature of at least about 95° C. for about 2 minutes.

6. A process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) with an organic solvent; and
(d) isolating the solid material from (c) to provide the cellulose-containing material.

7. The process of claim 6, wherein the organic solvent is selected from methyl formate, ethyl formate, ethyl acetate, acetone, ethyl alcohol and mixtures of any two or more thereof.

8. The process of claim 6 or 7, wherein the organic solvent is selected from 98-100% w/v methyl formate, 98-100% w/v ethyl formate, 20% w/v aqueous methyl formate and 9% w/v aqueous ethyl formate.

9. The process of any one of claims 6-8, wherein the treatment in (c) comprises rinsing the solid material from (b) with the organic solvent or immersing the solid material from (b) in the organic solvent.

10. A process for producing a cellulose-containing material comprising:
(a) contacting a cellulose source with a solvent comprising zinc ions and formic acid to provide a solution;
(b) extruding the solution from (a) into a coagulation bath to provide a solid material;
(c) treating the solid material from (b) in water at a temperature of at least about 95° C.; and
(d) isolating the solid material from (c) to provide the cellulose-containing material.

11. The process of claim 10, wherein the solid material is immersed in water at a temperature of at least about 95° C. for about 2 minutes.

12. The process of any one of claims 1-11, wherein the process further comprises isolating the solid material from (b) prior to (c).

13. The process of claim 12, wherein the process further comprises drying the isolated solid material prior to (c).

14. The process of any one of claims 1-11, wherein the process further comprises isolating the solid material from (b) concurrently with (c).

15. A process for producing a cellulose-containing material comprising:
(a) contacting a cellulose source with a solvent comprising zinc ions and formic acid to provide a solution;
(b) freezing and then thawing the solution from (a) to provide a thawed solution;
(c) extruding the thawed solution from (c) into a coagulation bath to provide a solid material; and
(d) isolating the solid material from (c) to provide the cellulose-containing material.

16. A process for producing cellulose formate comprising:
(a) contacting a cellulose source with a solvent comprising zinc ions and formic acid to provide a solution;
(b) adding water to the solution from (a) to provide a precipitate;
(c) isolating the precipitate from (b);
(d) immersing the precipitate from (c) in water;
(e) freezing the water in which the precipitate is immersed; and
(f) drying the precipitate from (d) to provide cellulose formate.

17. The process of claim 16, wherein the process further comprises grinding the cellulose formate material into a powder.

18. The process of claim 16 or 17, wherein (e) involves freezing the water for at least 2 hours.

19. A process for producing a cellulose-containing material comprising:
(a) dissolving the cellulose formate material of any one of claims 15-18 in a solvent to provide a solution;
(b) extruding the solution of (a) into a coagulation bath to provide a solid material;
(c) isolating the solid material from (b) to provide the cellulose-containing material.

20. The process of claim 19, wherein the solvent in (a) is selected from formic acid or dimethyl sulfoxide.

21. The process of any one of claims 1-15, 19 and 20, wherein the coagulation bath comprises a halide salt.

22. The process of claim 21, wherein the halide salt is selected from zinc chloride, zinc bromide, zinc iodide, sodium chloride, sodium bromide, sodium iodide, potassium chloride, potassium bromide, potassium iodide, chloride salts of other metals, bromide salts of other metals, iodide salts of other metals and mixtures of any two or more thereof.

23. The process of any one of claims 1-15 and 19-22, wherein the solution from (a) further comprises a protein source and the process produces a cellulose/protein-containing material.

24. The process of claim 23, wherein the protein source is keratin protein powder.

25. The process of any one of claims 1-15 and 19-24, wherein the solid material comprises a fibre or a film.

26. The process of any one of claims 1-25, wherein the cellulose source comprises cotton, wood pulp or a plant part.

27. The process of any one of claims 1-26, wherein the cellulose source comprises a mixture of two or more cellulose sources.

28. The process of any one of claims 1-27, wherein the solvent in (a) comprises less than about 10% w/w water, less than about 2% w/w water, or is substantially anhydrous.

29. The process of any one of claims 1-28, wherein the solvent in (a) comprises a solution of zinc formate and formic acid.

30. The process of any one of claims 1-29, wherein the concentration of zinc formate is about 20% w/v to about 40% w/v.

31. A material produced by a process of any one of claims 1-30.
